(19) United States
(12) Patent Application Publication
(10) Pub. No.: US 2026/0316224 A1
(43) Pub. Date: Oct. 15, 2026

(54) HANDHELD CLAMPING DEVICE

(71) Applicant: GRIPPLE LIMITED, Sheffield (GB)

(72) Inventors: SAMUEL BARNES, Sheffield (GB); DAN HERRANDO, Sheffield (GB)

(21) Appl. No.: 19/464,127

(22) Filed: Jan. 29, 2026

Related U.S. Application Data
(63) Continuation of application No. PCT/IB2024/060185, filed on Oct. 17, 2024.

(30) Foreign Application Priority Data
Oct. 18, 2023 (GB) 2315911.4
Oct. 16, 2024 (GB) 2415204.3

(51) Int. Cl. B25B 5/10

(52) U.S. Cl. CPC B25B 5/101; B25B 5/102

(57) ABSTRACT

According to various, but not necessarily all, examples there is provided a handheld clamping device 100 comprising: a first jaw part 102; a second jaw part 104; and a clamping mechanism 106 to control a separation between the first jaw part and the second jaw part to vary the size of an opening 108 therebetween, wherein the clamping mechanism is mounted to the second jaw part and is movably engaged to the first jaw part to enable the size of the opening to be varied, wherein the clamping mechanism extends from the first jaw part, behind the opening, to the second jaw part, and wherein the clamping mechanism comprises a tool-receiving portion 110 to receive a handheld tool, enabling tightening of the handheld clamping device against one or more articles 1, 2 between the first and second jaw parts.

This application is a continuation of PCT/IB2024/060185, having an International filing date of Oct. 17, 2024, which claims priority of GB Patent Application No. 2315911.4, filed Oct. 18, 2023 and GB Patent Application No. 2415204.3, filed Oct. 16, 2024. The disclosure of the foregoing are hereby incorporated by reference.

### FIELD OF THE INVENTION

Embodiments of the present invention relate to a handheld clamping device. In particular, but not exclusively, they relate to a handheld seismic bracing clamping device for suspended building services systems.

### BACKGROUND TO THE INVENTION

Temporary clamping devices are mechanically complex and often larger than needed, due to their reusability and adaptability. Many designs also cannot maintain a high degree of clamping pressure over an extended period of time.

Permanent clamping devices are secure over long periods, but often lack the convenience that some temporary clamping devices provide. Often, permanent clamping devices require more than two hands to operate due to the need to handle loose parts, nuts, bolts, etc.

### BRIEF DESCRIPTION OF VARIOUS EMBODIMENTS OF THE INVENTION

According to various, but not necessarily all, embodiments of the invention there is provided a handheld clamping device comprising:
a first jaw part;
a second jaw part; and
a clamping mechanism to control a separation between the first jaw part and the second jaw part to vary the size of an opening therebetween,
wherein the clamping mechanism is mounted to the second jaw part and is movably engaged to the first jaw part to enable the size of the opening to be varied,
wherein the clamping mechanism extends from the first jaw part, behind the opening, to the second jaw part, and
wherein the clamping mechanism comprises a tool-receiving portion to receive a handheld tool, enabling tightening of the clamping device against one or more articles between the first and second jaw parts.

An advantage is that the handheld clamping device is convenient to use because the built-in rear-mounted clamping mechanism allows the size of the opening to be varied, while also being capable of providing a high clamping force due to the tool-receiving portion.

According to various, but not necessarily all, embodiments of the invention there is provided a handheld clamping device comprising:
a first jaw part;
a second jaw part; and
a clamping mechanism to control a separation between the first jaw part and the second jaw part to vary the size of an opening therebetween,
wherein the clamping mechanism is mounted to the second jaw part and is slidably engaged to the first jaw part to enable the first and second jaw parts to translate linearly relative to each other, to linearly vary the size of the opening while the first and second jaw parts remain parallel to each other, and
wherein the clamping mechanism extends from the first jaw part, behind the opening, to the second jaw part.

An advantage is that the clamping device is convenient to use, because the clamping mechanism is rearwardly mounted and yet the jaws remain parallel to each other due to the linear sliding.

The first jaw part may have a fixed geometry and the second jaw part may have a fixed geometry. Tightening the clamping mechanism may translate the fixed geometry jaw parts towards each other.

The first and second jaw parts may have a single degree of freedom of movement relative to each other. The first and second jaw parts may be slidable linearly. This may linearly vary the size of the opening while the first and second jaw parts remain substantially parallel to each other

The opening may be located at a front side of the clamping device. The clamping mechanism may extend along a rear side of the clamping device.

The clamping mechanism may extend behind an internal space of the clamping device between the first and second jaw parts, within which the one or more articles can be received.

The clamping mechanism may extend along a back wall of the clamping device, defining a rear boundary of the internal space. The first jaw part may comprise a rear portion defining a first portion of the back wall of the clamping device, and a protruding jaw portion extending forward from the rear portion and defining a side boundary of the internal space. The second jaw part may comprise a rear portion defining a second portion of the back wall of the clamping device, and a protruding jaw portion extending forward from the rear portion and defining another side boundary of the internal space. The clamping mechanism may extend along the rear portions of the first and second jaw parts.

The clamping device may be in the shape of a C-clamp (also referred to as a G-clamp). For example, the internal space may be generally C-shaped, defined by the shapes of the first and second jaw parts. For example, the C-shaped internal space may be defined by the side boundaries and the rear boundary described above.

The first jaw part may comprise a concave seat to contact one of the articles. The second jaw part may comprise a concave seat to contact another of the articles, or an opposite side of the same article. An advantage is improved retention of articles having shapes that fit into the concavities. For example, the seats may be curved and the articles may be cylindrical.

The concave seats of the first and second jaw parts may have different radii (circle-equivalent radii). This allows elongate articles of different dimensions or diameters to be clamped alongside each other. Advantageously, the tool-receiving portion and concave seats allow the clamping device to hang a heavy upright-hanging elongate article against the side of a support, the normal force and consequent friction being sufficient to prevent the elongate article from slipping down through the clamping device and dropping to the ground.

The concave seats are useful for applications in the seismic bracing sector, for clamping an upright bracing member against the side of an upright suspended threaded rod, the rod supporting a suspended frame for suspended building services systems (ducts, pipes, conduits, ceilings, etc). The bracing member limits flexure of the rod to limit swaying of the frame, and the clamping device ensures the bracing member is tightly and permanently clamped against the rod. The clamping device may be a seismic bracing clamping device for suspended building services systems. However, the clamping device may also be useful in other sectors.

The first and second jaw parts may be slidably engaged with each other. The first and second jaw parts may be slidably engaged with each other in an overlapping manner. For example, the rear portions of the first and second jaw parts may be slidably engaged with each other in an overlapping manner.

The first and second jaw parts may be telescopically slidable with respect to each other. The first jaw part may comprise a first telescoping portion and the second jaw part may comprise a second telescoping portion, the first and second telescoping portions being telescopically slidable with respect to each other. For example, the rear portions of the first and second jaw parts may each define a respective one of the first and second telescoping portions.

The clamping mechanism may extend through the first and second telescoping portions.

The clamping mechanism may be slidably engaged to the first jaw part while being mounted to the second jaw part.

The clamping mechanism may be a bar clamp mechanism. The bar clamp mechanism may comprise a bar (e.g., bolt shaft) slidably engaged to the first jaw part while being mounted to the second jaw part.

The bar may extend through a channel in the first jaw part. The bar may extend along the rear portions of the first and second jaw parts. The bar may extend through the first and second telescoping portions.

Where the clamping mechanism may comprise a threaded portion to enable tightening of the clamping device against one or more articles between the first and second jaw parts.

The threaded portion may be mounted rearwards on the handheld clamping device, extending behind the opening.

The threaded portion may be generally parallel to a sliding axis of the clamping mechanism.

The threaded portion may be located coaxially with a sliding axis of the clamping mechanism.

A portion of the bar which is mounted to the second jaw part may comprise the threaded portion. The second jaw part may comprise or contain a corresponding mating threaded portion (e.g., nut), enabling the bar to be mounted in threaded engagement to the second jaw part.

The nut may be a captive nut. The captive nut may be retained in a recess of the second jaw part. An advantage is convenience because the worker does not need more than two hands to manipulate the various parts of the clamping device.

The clamping mechanism may comprise a breakaway portion. In some examples, the nut may be a shear nut, comprising the breakaway portion. Alternatively, the clamping mechanism may comprise a shear bolt comprising the breakaway portion.

The shear nut may comprise a nut portion breakably coupled to an anti-rotation portion. The anti-rotation portion may prevent rotation between the shear nut and the second jaw part. Once the nut portion has broken away from the anti-rotation portion, the nut portion may be rotatable relative to the second jaw part.

An advantage is that if the maximum torque is specified, a shear nut will ensure that the clamping device is not over-torqued. Once the required torque is reached, the shear nut will break and the remaining nut portion will freely rotate.

The clamping mechanism may comprise a spreader input (e.g., bolt head) which, when actuated, spreads the second jaw part apart from first jaw part to enlarge the opening to enable the clamping device to be secured to the one or more articles. Actuating of the spreader input may comprise pushing the spreader input to slide the second jaw part away from the first jaw part.

The spreader input may be located towards a first end of the bar proximal to the first jaw part. The threaded portion of the bar may be located towards a second end of the bar proximal to the second jaw part. The spreader input may comprise an enlarged head to which the bar is mounted.

Where the clamping mechanism may comprise a tool-receiving portion, the spreader input may comprise the tool-receiving portion. For example, the spreader input may be a fastener head, such as a hex-shaped head or a head having a tool socket, or any other appropriate fastener head. In some examples, the fastener head is a breakaway portion of a shear bolt.

The clamping mechanism may comprise a spring urging the first and second jaw parts towards each other.

The spring may be mounted rearwards on the handheld clamping device, an axis of the spring extending behind the opening.

The spring may be generally parallel to the threaded portion described earlier.

The spring may be located coaxially with the threaded portion. The spring may wrap around a shaft that comprises the threaded portion.

The spring may be located coaxially with a sliding axis of the clamping mechanism.

The spring may be a compression spring, such as a coil spring. The spring may extend in a coaxial direction with the bar. One end of the spring may be mounted to the first jaw part, and the other end of the spring may be mounted to a portion of the clamping mechanism (e.g., underside of the spreader input).

Actuation of the spreader input may deflect (e.g., compress) the spring, acting against an urging force of the spring. Release of the spreader input may enable the spring to return the second jaw part towards the first jaw part to engage the one or more articles.

Tightening of the clamping mechanism via the threaded portion may further deflect the spring.

The first jaw part may comprise a ledge formation to provide purchase for at least a first digit of a hand of a user. The spreader input may be actuatable by another digit of the same hand of the user, to spread the second jaw part away from first jaw part to enlarge the opening to enable one or more articles to be received between the first and second jaw parts via the opening.

An advantage is convenience because the clamping mechanism can be actuated with a single hand.

The ledge formation may provide left and right ledges for first and second digits of the hand, such as first and second fingers. The spreader input may be actuatable by a thumb of the same hand, to spread the second jaw part away from the first jaw part.

When the clamping mechanism is at a travel limit, the spreader input and ledge formation may be simultaneously reachable by the respective digits of the same hand of the user, to enable the respective digits to squeeze the spreader input and ledge formation together to increase the size of the opening. For example, at the travel limit, the spreader input and ledge formation may be within 10 cm of each other, or within 5 cm of each other.

The clamping mechanism may have a degree of freedom of motion between expanded and retracted-opening travel limits. These travel limits refer to expansion and retraction of the opening. When the clamping mechanism is at the expanded-opening travel limit, the second jaw part may be further away from the first jaw part than when the clamping mechanism is at the retracted-opening travel limit. When the clamping mechanism is at the retracted-opening travel limit, the spreader input may be further away from the ledge formation of the first jaw part than when the clamping mechanism is at the expanded-opening travel limit. The travel limit referred to in the previous paragraph may be the retracted-opening travel limit.

An overall advantage based on combinations of the above features is a convenient but strong handheld clamping device. Only one hand is required to initially engage the clamping mechanism with one or more articles to be clamped, while the other hand holds at least one of the articles in the required position. There is no need to handle loose nuts and bolts. Then, once the clamping mechanism is initially engaged but not yet tightened, the user can let go of the clamp, pick up a tool, and tighten the clamping device to the required torque. Once the clamp has been tightened, further clamps can be engaged and tightened to the same article(s) with only one hand. Various features described above also enable the clamping device to be a mass-produced permanent clamping device, rather than a temporary clamping device.

### BRIEF DESCRIPTION OF THE DRAWINGS

For a better understanding of various examples of embodiments of the present invention reference will now be made by way of example only to the accompanying drawings in which:

FIGS. 1A-1B illustrate perspective views of an example handheld clamping device;

FIGS. 2A-2B illustrate cross-section views of the handheld clamping device;

FIGS. 3A-3B illustrate rear views of the handheld clamping device; and

FIG. 4 illustrates an example where a bolt is a shear bolt.

### DETAILED DESCRIPTION OF VARIOUS EMBODIMENTS OF THE INVENTION

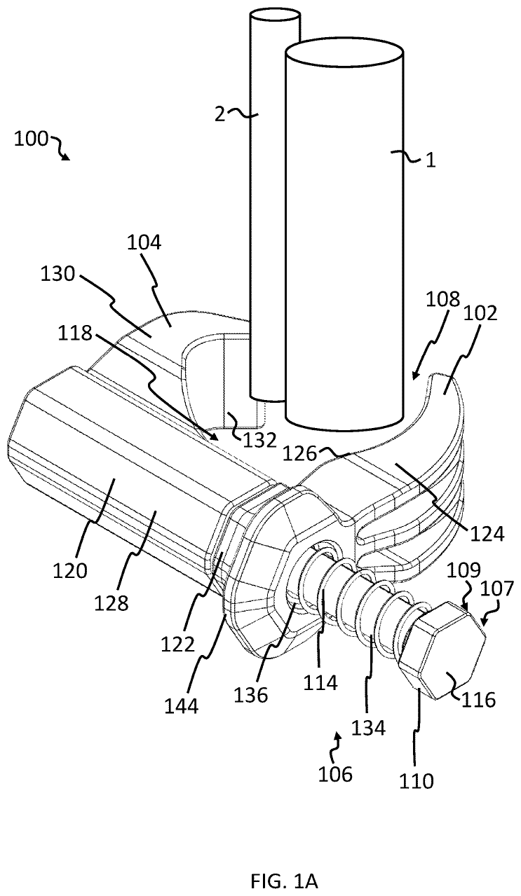

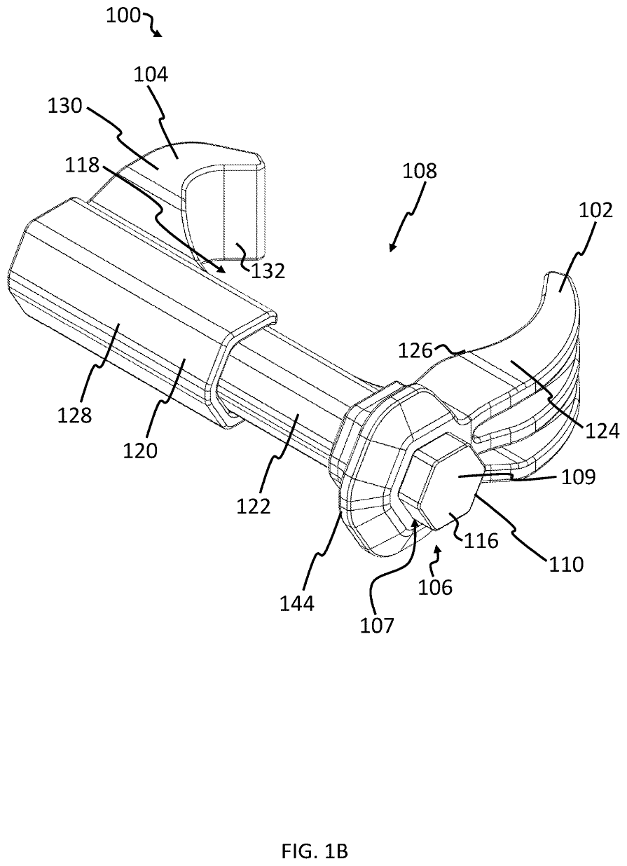

FIGS. 1A-3B illustrate an example of a handheld clamping device 100.

The handheld clamping device 100 comprises a first jaw part 102 and a second jaw part 104, together defining a C-shaped internal space 118 therebetween, accessed through an opening 108 between the tips of the first and second jaw parts 102, 104, the opening 108 being at a front side of the clamping device 100.

The jaw parts face each other, and each jaw part comprises a rear portion 122, 128 and a protruding jaw portion 124, 130. The rear portions 122, 128 together define a back wall 120 extending along the rear side of the clamping device 100, and are telescoping portions that are telescopically slidable with respect to each other to extend and retract the back wall 120 of the clamping device 100. Each protruding jaw portion 124, 130 protrudes forwardly from the back wall 120 and comprises a concave seat 126, 132 to contact an elongate article 1, 2 (FIG. 1A). The concave seats 126, 132 and the back wall 120 of the jaw parts define the side and rear boundaries of the C-shaped internal space 118, respectively.

When the clamping device 100 is used for seismic bracing or similar applications, the clamping device 100 may attach to a pair of upright elongate articles 1, 2 as shown in FIG. 1A. The first elongate article 1 is an upright bracing member and the second elongate article 2 is an upright threaded rod, extending parallel to and against the first elongate article 1.

The predetermined shapes of the jaw parts 102, 104 are adapted to the shapes of the articles 1, 2. Due to the different diameters of the elongate articles 1, 2, the jaws may have differently shaped concave seats 126, 132 than each other, for contacting the elongate articles 1, 2. In FIG. 1A, the concave seat 126 of the first jaw part 102 has a greater effective radius to seat the larger diameter first elongate article 1, whereas the concave seat 132 of the second jaw part 104 has a smaller effective radius to seat the smaller diameter second elongate article 2. It would be appreciated that different versions of the clamping device 100 for clamping different articles may have differently shaped jaw parts, depending on the application. Generic jaw part shapes could be used for a general clamp, for example one or both jaw parts may have a flat seat, or the jaw parts may have equal-diameter concave seats.

The first and second jaw parts 102, 104 can be loosely slid towards and away from each other. The Figures show a clamping mechanism 106 to perform this operation, to vary the size of the opening 108 between the first and second jaw parts 102, 104. The clamping mechanism 106 is further configured to enable final tightening of the first and second jaw parts 102, 104 to provide a permanent connection.

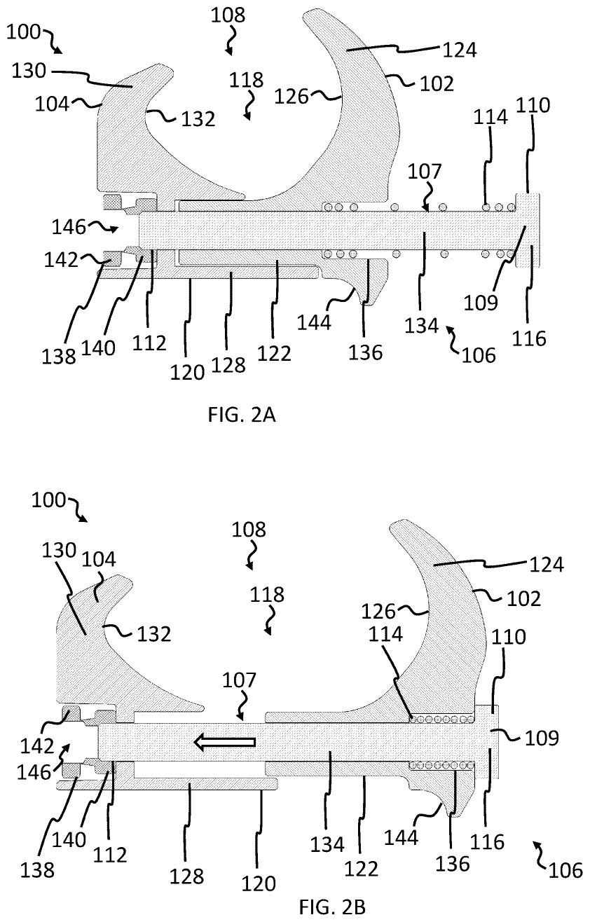

The illustrated clamping mechanism 106 defines a bar clamping mechanism. The bar clamping mechanism is provided by a spring-loaded fastener in the form of a bolt 107 extending through the back wall 120 of the clamping device 100. The bolt 107 has a head 109 and a shaft 134 (bar) connected thereto. The shaft 134 of the bolt 107 slidably extends through the first jaw part 102, specifically through and out of a channel 136 in the rear portion 122 of the first jaw part 102. The distal end of the shaft 134 of the bolt 107 mounts to a captive nut 138 (FIGS. 2A-2B) encapsulated in a recess 146 within the second jaw part 104.

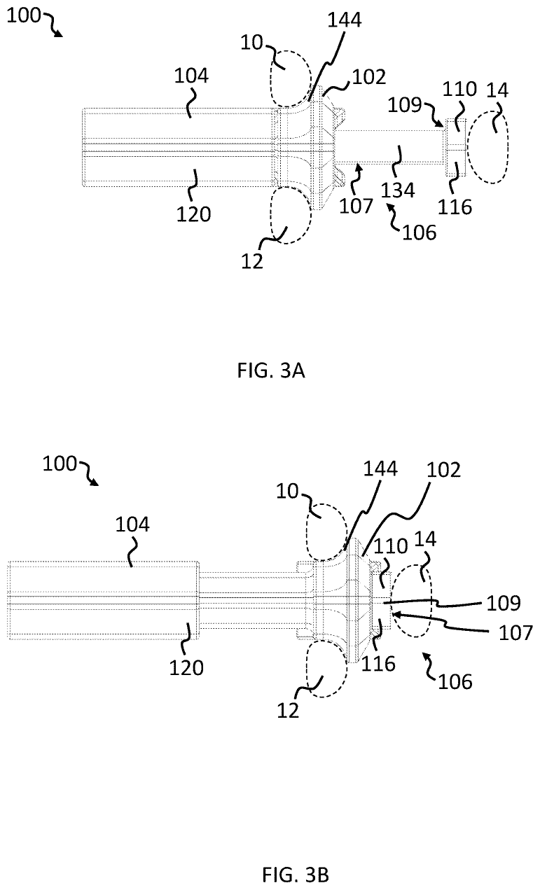

The top surface of the head 109 of the bolt 107 defines an input 116 that can be pressed by a user's thumb 14 (FIGS. 3A-3B) to slide the head 109 of the bolt 107 towards the first jaw part 102. Since the shaft 134 of the bolt 107 is slidable relative to the first jaw part 102 through the channel 136 but is fixedly mounted to the second jaw part 104, this causes an assembly (defined by the bolt 107 and the second jaw part 104) to slide apart from the first jaw part 102, enlarging the opening 108. The head 109 of the bolt 107 can therefore be defined as a spreader input 116, because depressing the bolt 107 causes the opening 108 to expand rather than retract.

Depressing the head 109 of the bolt 107 compresses the spring 114 between the head 109 of the bolt 107 and a spring seat in the channel 136 of the first jaw part 102, until an expanded-opening travel limit (FIGS. 1B, 2B, 3B) is reached. This limit is defined by the head 109 of the bolt 107 hitting the first jaw part 102, or by the spring 114 becoming coil-bound. When the head 109 of the bolt 107 is released, the spring 114 urges the assembly defined by the bolt 107 and the second jaw part 104 back to a retracted-opening travel limit (FIGS. 1A, 2A, 3A).

To enable one-handed expansion of the opening 108, the first jaw part 102 comprises a ledge formation 144. As shown in FIGS. 3A-3B, the ledge formation 144 has left and right ledges to the left and right sides of the shaft 134, to provide symmetric purchase for a pair of digits 10, 12 (fingers) of the user, such as the index and middle fingers. At the same time, the thumb digit 14 of the same hand depresses the head 109 of the bolt 107 to slide the bolt 107. At the retracted-opening travel limit, the head 109 of the bolt 107 is close enough (e.g., <10 cm or <5 cm) to the ledge formation 144 that the user can single-handedly grip the ledge formation 144 with both fingers 10, 12 of a hand, and push the head 109 of the bolt 107 with the thumb 14 of the same hand. As a result, a squeezing motion of the hand spreads the first and second jaw parts 102, 104 from each other. The ledge formation 144 and head 109 of the bolt 107 enable one-handed operation, so that the user can grasp one or both of the elongate articles 1, 2 with their other hand.

Once the user has fitted the clamping device 100 to the elongate articles 1, 2, the user can stop depressing the head 109 of the bolt 107, and the spring 114 will cause the clamping device 100 to close up and secure itself to the elongate articles 1, 2. The user can remove their hand from the clamping device 100. However, this engagement is fairly loose and therefore a tightening means is provided to enable a permanent connection with a high load capacity. The user can use their free hand which previously held the clamping device 100, to pick up a handheld tool and operate the tightening means.

To provide the tightening means, FIGS. 2A-2B show that the shaft 134 of the bolt 107 comprises a threaded portion 112 engageable with the threads of the captive nut 138. The head 109 of the bolt 107 is faceted/hex-shaped to define a tool-receiving portion 110 for receiving a spanner/wrench or socket tool or other handheld tool. Alternatively, or additionally, the head 109 of the bolt 107 can comprise a socket for receiving a screwdriver or key or other handheld tool. By engaging the handheld tool (not shown) with the head 109 of the bolt 107 and using it to rotate the bolt 107, the bolt 107 is tightened to the captive nut 138 which urges the first and second jaw parts 102, 104 even closer together to tightly clamp them against the elongate articles 1, 2.

If over-torquing is to be avoided, the illustrated captive nut 138 can be implemented as a shear nut, as shown in FIGS. 2A-2B. The captive nut 138 comprises a threaded nut portion 140 breakably coupled to an anti-rotation portion 142 via a thin breakable shear groove (local thin area), to define a shear nut.

The anti-rotation portion 142 is a polygonal portion (e.g., hex-shaped) tightly fitted against a corresponding polygonal-shaped side wall of the recess 146 in the second jaw part 104. The anti-rotation portion 142 therefore cannot rotate within the recess 146.

When a predetermined torque is reached, the nut portion 140 breaks away from the anti-rotation portion 142 of the captive nut 138. The nut portion 140 can then freely rotate within the recess 146 in the second jaw part 104, so that further rotation of the head 109 of the bolt 107 results in no further tightening or torquing of the bolt 107.

In other examples, the bolt 107 is a shear bolt, wherein the head 109 of the bolt 107 is breakably coupled to the threaded portion 112 of the shaft 134 of the bolt 107 via a thin breakable shear groove (local thin area).

An advantage of the illustrated clamping device 100 is that it is optimised for high-volume low-cost manufacture due to the type of parts used, while also being suitable for one-handed operation.

The jaw parts 102, 104 of the clamping device 100 may be formed from plastics material. Alternatively, metal may be used.

Although embodiments of the present invention have been described in the preceding paragraphs with reference to various examples, it should be appreciated that modifications to the examples given can be made without departing from the scope of the invention as claimed. For example, the bolt 107 and spring 114 are illustrated as being coaxial to each other, but in other examples may be non-coaxial with each other, and either parallel or non-parallel to each other.

Although the clamping mechanism 106 is illustrated as being slidably engaged to the first jaw part 102, alternatively the first and/or second jaw parts 102, 104 may be flexible (e.g., formed from rubber or similar materials) to facilitate initial engagement with the articles 1, 2. The clamping mechanism may lock the flexible jaw parts 102, 104 in any appropriate manner.

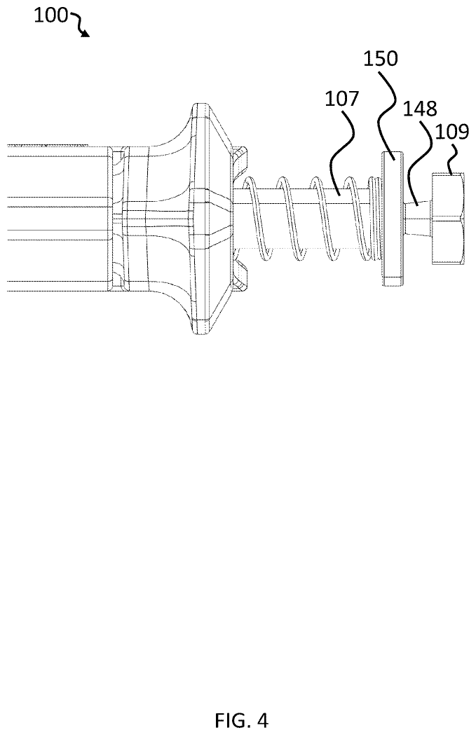

FIG. 4 illustrates an example where the bolt 107 is a shear bolt. The head 109 of the bolt 107 is breakably coupled to a spring seat flange 150 located proximal to the head 109, by a break-off portion 148 configured to break when a predetermined torque is reached.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A clamping device comprising:
a first jaw part;
a second jaw part; and
a clamping mechanism to control a separation between the first jaw part and the second jaw part to vary the size of an opening therebetween, the clamping mechanism comprising a spring urging the first and second jaw parts towards each other,
wherein the first and second jaw parts are slidable linearly to vary the size of the opening while the first and second jaw parts remain substantially parallel to each other,
wherein the clamping mechanism is mounted to the second jaw part and is movably engaged to the first jaw part to enable the size of the opening to be varied,
wherein the clamping mechanism extends from the first jaw part, behind the opening, to the second jaw part,
wherein the clamping mechanism comprises a spreader input configured to, when actuated, cause the spring to deflect, acting against an urging force of the spring to linearly spread the second jaw part apart from the first jaw part to enlarge the opening to enable the clamping device to be secured to one or more articles, and
wherein the clamping mechanism comprises a tool-receiving portion to receive a handheld tool, enabling tightening of the clamping device against the one or more articles between the first and second jaw parts after the clamping device has been secured to the one or more articles.

2. A clamping device comprising:
a first jaw part comprising a concave seat;
a second jaw part comprising a concave seat having a different radius to the concave seat of the first jaw part; and
a clamping mechanism to control a separation between the first jaw part and the second jaw part to vary the size of an opening therebetween,
wherein the first and second jaw parts are slidable linearly to vary the size of the opening while the first and second jaw parts remain substantially parallel to each other,
wherein the clamping mechanism is mounted to the second jaw part and is movably engaged to the first jaw part to enable the size of the opening to be varied,
wherein the clamping mechanism extends from the first jaw part, behind the opening, to the second jaw part, and
wherein the clamping mechanism comprises a tool-receiving portion to receive a handheld tool, enabling tightening of the clamping device against one or more articles between the first and second jaw parts such that the concave seat of the first jaw part contacts one of the one or more articles and the concave seat of the second jaw part contacts a second article.

3. A clamping device comprising:
a first jaw part;
a second jaw part; and
a clamping mechanism to control a separation between the first jaw part and the second jaw part to vary the size of an opening therebetween,
wherein the first and second jaw parts have a single degree of freedom of movement relative to each other, and wherein the first and second jaw parts are slidable linearly to vary the size of the opening while the first and second jaw parts remain substantially parallel to each other,
wherein the clamping mechanism is mounted to the second jaw part and is movably engaged to the first jaw part to enable the size of the opening to be varied,
wherein the clamping mechanism extends from the first jaw part, behind the opening, to the second jaw part,
wherein the clamping mechanism comprises a tool-receiving portion to receive a handheld tool, enabling tightening of the clamping device against one or more articles between the first and second jaw parts, and
wherein the clamping mechanism comprises a breakaway portion configured to prevent tightening of the clamping device beyond a predetermined torque.

4. A system comprising:
an upright bracing member;
an upright suspended threaded rod; and
a clamping device configured to clamp the upright bracing member against the side of the upright suspended threaded rod, the clamping device comprising:
a first jaw part;
a second jaw part; and
a clamping mechanism to control a separation between the first jaw part and the second jaw part to vary the size of an opening therebetween, the clamping mechanism comprising a spring urging the first and second jaw parts towards each other,
wherein the clamping mechanism is mounted to the second jaw part and is movably engaged to the first jaw part to enable the size of the opening to be varied,
wherein the first and second jaw parts are slidable linearly to vary the size of the opening while the first and second jaw parts remain substantially parallel to each other,
wherein the clamping mechanism extends from the first jaw part, behind the opening, to the second jaw part,
wherein the clamping mechanism comprises a spreader input configured to, when actuated, cause the spring to deflect, acting against an urging force of the spring to linearly spread the second jaw part apart from the first jaw part to enlarge the opening to enable the clamping device to be secured to the upright bracing member and the upright suspended threaded rod, and
wherein the clamping mechanism comprises a tool-receiving portion to receive a handheld tool, enabling tightening of the clamping device against the upright bracing member and the upright suspended threaded rod between the first and second jaw parts after the clamping device has been secured to the upright bracing member and the upright suspended threaded rod.

5. The clamping device according to claim 1, wherein the first jaw part comprises a ledge formation to provide purchase for at least a first digit of a hand of a user, and wherein the spreader input is actuatable by another digit of the same hand of the user.

6. The clamping device according to claim 1, wherein the clamping mechanism comprises a breakaway portion configured to prevent tightening of the clamping device beyond a predetermined torque.

7. The clamping device according to claim 1, wherein the first jaw part has a fixed geometry and the second jaw part has a fixed geometry, and wherein tightening the clamping mechanism translates the fixed geometry jaw parts towards each other.

8. The handheld clamping device according to claim 1, wherein the first and second jaw parts have a single degree of freedom of movement relative to each other.

9. The clamping device according to claim 1, wherein the clamping mechanism extends along a back wall of the clamping device, behind an internal space of the clamping device between the first and second jaw parts, within which the one or more articles can be received, thereby defining a rear boundary of the internal space.

10. The clamping device according to claim 9, wherein the first jaw part comprises a rear portion defining a first portion of the back wall of the clamping device, and a protruding jaw portion extending forward from the rear portion and defining a first side boundary of the internal space, and wherein the second jaw part comprises a rear portion defining a second portion of the back wall of the clamping device, and a protruding jaw portion extending forward from the rear portion and defining a second side boundary of the internal space.

11. The clamping device according to claim 10, wherein the clamping mechanism extends along the rear portions of the first and second jaw parts.

12. The clamping device according to claim 1 wherein the first jaw part comprises a concave seat configured to contact one of the one or more articles, and wherein the second jaw part comprises a concave seat configured to contact another of the one or more articles, or an opposite side of the same article, wherein the concave seats of the first and second jaw parts have different radii.

13. The clamping device according to claim 1, wherein the clamping mechanism comprises a threaded portion to enable tightening of the clamping device against the one or more articles between the first and second jaw parts.

14. The clamping device according to claim 13, wherein the threaded portion comprises a captive nut retained in a recess of the second jaw part.

15. The clamping device according to claim 1, wherein the first and second jaw parts are slidably engaged with each other in an overlapping manner, and wherein the first jaw part comprises a first telescoping portion and the second jaw part comprises a second telescoping portion, the first and second telescoping portions being telescopically slidable with respect to each other.

16. The clamping device according to claim 15, wherein the clamping mechanism extends through the first and second telescoping portions, and wherein the clamping mechanism is slidably engaged to the first jaw part while being mounted to the second jaw part.

17. The clamping device according to claim 15, wherein the clamping mechanism is a bar clamp mechanism comprising a bar slidably engaged to the first jaw part while being mounted to the second jaw part.

18. The clamping device according to claim 17, wherein a portion of the bar which is mounted to the second jaw part comprises a threaded portion, to enable tightening of the clamping device against the one or more articles between the first and second jaw parts, and wherein the second jaw part comprises a corresponding mating threaded portion, enabling the bar to be mounted in threaded engagement to the second jaw part.

19. The clamping device according to claim 1, wherein the spreader input comprises the tool-receiving portion.

20. The clamping device according to claim 1, wherein one end of the spring is mounted to the first jaw part, and the other end of the spring is mounted to a portion of the clamping mechanism.
